(19) United States
(12) Patent Application Publication
(10) Pub. No.: US 2024/0006093 A1
(43) Pub. Date: Jan. 4, 2024

(54) WIRELESS POWER TRANSFER SYSTEM WITH RECEIVING ANTENNA THAT ACHIEVES INDUCTIVE COUPLING

(71) Applicant: Global Energy Transmission, Co., Woodland, WA (US)

(72) Inventors: Sergey PLEKHANOV, Moscow (RU); Leonid PLEKHANOV, Queretero (MX)

(21) Appl. No.: 18/169,087

(22) Filed: Feb. 14, 2023

Related U.S. Application Data
(60) Provisional application No. 63/310,068, filed on Feb. 14, 2022.

(51) Int. Cl. H01B 1/02; H02J 50/10

(52) U.S. Cl. CPC H01B 1/023; H02J 50/10

(57) ABSTRACT

A conductor for a high-current wireless power transfer (WPT) system includes plural thin-walled tubes formed from aluminum alloys and other materials and alloys with features that are similar to aluminum alloys. The tubes are sufficiently rigid so that they are self-supporting when used in a WPT system, and each of the tubes has a skin layer of about 0.28 mm, and a wall thickness in the range of about 6-12 mm. Plural cuts are formed along the longitudinal axis of each tube, and the plural cuts are effective to increase heat transfer from heat-generating parts of the WPT system to the surrounding area, thereby to aid in cooling. For a tube with an external diameter of about 6 mm, the plural cuts are formed with the dimensions of 1.5 mm width×40 mm length.

### CROSS-REFERENCE TO RELATED APPLICATIONS

This application claims priority to U.S. Provisional Patent Application Ser. No. 63/310,068, filed Feb. 14, 2022, the disclosure of which is herein incorporated by reference.

### CROSS-REFERENCES TO MATERIALS INCORPORATED BY REFERENCE

Also incorporated herein by reference are the following U.S. patent applications: (1) U.S. patent application Ser. No. 18/161,817, filed Jan. 30, 2023; (2) U.S. patent application Ser. No. 16/581,559, filed Sep. 24, 2019; and (3) U.S. Provisional Patent Application Ser. No. 63/484,943, filed Feb. 14, 2023.

### INTRODUCTION

To achieve inductive coupling in wireless power transfer (WPT) systems, a new WPT system includes a high-Q LC-circuit for the receiving antenna. Conventional receiving antennas tend to overheat if there is high power-energy transfer that is associated the high Q factor and high current of the circuit.

An optimized structure of a coil of a receiving antenna for inductive coupling in a WPT system is useful for applications that require: (i) low weight, such as aerial vehicles like UAVs (unmanned aerial vehicles) or a VTOLs (vertical takeoff and landing aircraft), or robotics; and (ii) low temperature of the corresponding antenna coil.

Conventional WPT systems use a solid, single, relatively thick wire as a conductor for high frequency currents (above 10 kHz). Because of a so-called skin-effect, a substantial part of the wire is useless for WPT purposes, due to current flow in a thin-surface layer of a conductor called skin layer. For example, at a frequency of 100 kHz, the thickness of the skin layer in copper is 0.2 mm. At that frequency, a wire of 5 mm diameter will have effective ohmic losses roughly equal to those of 0.7 mm diameter wire for DC current. To decrease the amount of useless weight of a conductor for high frequency applications, conventional systems use a so-called litz wire, which is a wire composed of multiple, thin, separate, insulated strands. The diameter of each strand is comparable with the thickness of a skin layer for the required frequency. This type of conventional system uses a substantial part of the total cross section of the strands for current conduction and, as a result, there is a decrease in ohmic losses and in the weight of the wire.

However due to their complex internal structure, litz wires have poor heat transfer capabilities. Despite desirably low ohmic losses, the problem of overheating still exists for high-current applications. Also, litz wires are relatively soft and not durable, so they require environmental protection, which undesirably increases the weight of a receiving antenna and exacerbates the problem of antenna overheating.

### BRIEF DESCRIPTION OF THE DRAWINGS

FIG. 1 is a table that shows how the invention includes a system that provides cooling of WPT systems for a range of geometries, and for each voltage driving an LC-circuit that includes an appropriate tube, the temperature of a tube sample was measured for three different samples at different points of a tube

### INVENTIONS THAT OVERCOME OVERHEATING AND EXCESSIVE WEIGHT PROBLEMS OF CONVENTIONAL SYSTEMS

Instead of using a litz wire, the invention involves using thin-wall aluminum tubes. Aluminum has lower ohmic losses for the same weight and length of a conductor compared to a copper conductor. For examples, the ohmic resistance of aluminum is 0.028 Ω*mm²/m, which is 1.6 times higher than that of copper (0.017 Ω*mm²/m). However, the density of aluminum (2700 kg/m³) is 3.3 times lower than density of a copper (8900 kg/m³). Thus, an aluminum conductor that has ohmic resistance equal to that of a copper conductor will have almost 2 times lower weight (although cross section of such aluminum conductor will be 1.64 times higher than that of a copper conductor).

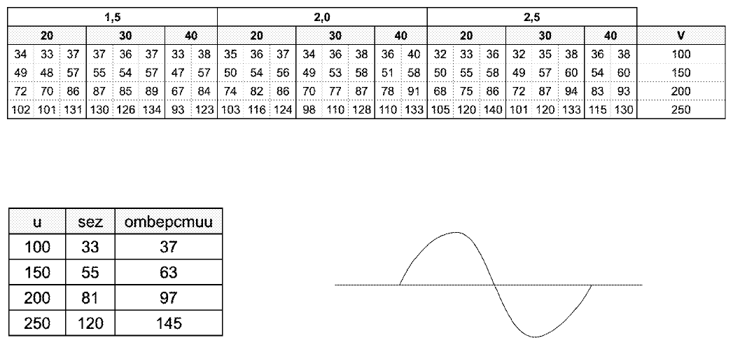

For the frequency of operation of WPT system, it is also preferable that the thickness of a wall of a conductor is not substantially greater than the thickness of a skin layer. The overheating problem must also be addressed. To solve the above-described problems, the invention involves using thin-walled tubes as a conductor for a high-current WPT antenna, and it includes the following features:
1. The preferred material is an aluminum alloy, and any other material that has similar qualities. The aluminum conductor has a lower weight than copper one, and does not require special environmental protection like the above-described ones associated with litz wire conductors. Aluminum tubes are also sufficiently rigid so it is unnecessary for external support, which results in additional weight decrease.
2. The preferred wall thickness of the tube should not substantially exceed the thickness of a skin layer for the frequency of operation of WPT system. For example, at 100 kHz frequency, aluminum has a 0.28 mm skin layer, therefore the optimal wall thickness for an aluminum tube is about 0.28 mm. Versions of the tube that have 6 mm-, 8 mm-, and 12 mm-external diameters with wall thicknesses of 0.3 mm were used. Those tube wall thicknesses result in full usage of the cross-sectional area of the tube, which result in decreases of ohmic losses/heating. Those tube versions also have a desirably high ratio between an external surface and the conductor cross-section, which results in a natural heatsink that accommodates relatively high current for the same cross section (compared to conventional wire-structure conductors) and, additionally, there is decreased weight of the corresponding WPT antenna.
3. Additional cuts made along the longitudinal axis of the tube will increase heat transfer to the surrounding area, which provides better cooling. According to experimental results, the optimal geometry of the additional cuts is 1.5 mm width×40 mm length for tubes with a 6 mm external diameter. As shown in FIG. 1, improved system cooling can be obtained for a range of geometries, and for each voltage driving an LC-circuit that includes an appropriate tube, the temperature of a tube sample was measured for three different samples at different points of a tube.
4. The preferred placement of a conducting tube is under the blades of a UAV or a VTOL, and that placement causes forced air cooling of such conductor without needing to add any additional weight.

The methods and systems set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed:

1. A conductor for a high-current wireless power transfer (WPT) system comprising:
plural thin-walled tubes formed from the group consisting of aluminum alloys and other materials and alloys with features that are similar to aluminum alloys, and wherein the tubes are sufficiently rigid so that they are self-supporting when used in a WPT system.

2. The conductor of claim 1, wherein each of the tubes has a skin layer of about 0.28 mm, and a wall thickness in the range of about 6-12 mm.

3. The conductor of claim 2, wherein plural cuts are formed along the longitudinal axis of each tube, and the plural cuts are effective to increase heat transfer from heat-generating parts of the WPT system to the surrounding area, thereby to aid in cooling.

4. The conductor of claim 3, wherein each tube has an external diameter of about 6 mm, and each of the plural cuts are formed with the dimensions of 1.5 mm width×40 mm length.
